(19) United States
(12) Patent Application Publication
(10) Pub. No.: US 2024/0106122 A1
(43) Pub. Date: Mar. 28, 2024

(54) Compact, single near-field communication (NFC) antenna utilized for multiple functions in a smart ring

(71) Applicant: Plume Design, Inc., Palo Alto, CA (US)

(72) Inventors: Miroslav Samardzija, Mountain View, CA (US); Hsiangyin Cheng, Taipei City (TW); Shu Chun Shen, Taipei City (TW); Liem Hieu Dinh Vo, San Jose, CA (US)

(21) Appl. No.: 17/951,498

(22) Filed: Sep. 23, 2022

(51) Int. Cl. H01Q 7/00; H01Q 1/22

(52) U.S. Cl. CPC H01Q 7/00; H01Q 1/2208; H01Q 1/2275; H01Q 1/2283

(57) ABSTRACT

A near-field communication (NFC) antenna system comprising an antenna, a plurality of chips, and an antenna matching network connected on one side to the plurality of chips and on another side to the antenna. Wherein only one of the plurality of chips is active at a time with inactive chips have an impedance set combined with the antenna matching network to provide antenna matching with the active chip. The NFC antenna inactive chips are set to open having a corresponding impedance and the impedance is set based on any of transmission line length, width, and gap between. The plurality of chips includes a charging chip and a payment chip.

### FIELD OF THE DISCLOSURE

The present disclosure generally relates to antenna systems and methods. More specifically, the present disclosure relates to a compact, single near-field communication (NFC) antenna utilized for multiple functions, such as wireless charging and wireless payment radios, in a smart ring.

### BACKGROUND OF THE DISCLOSURE

Smart devices are electronic devices generally connected to other devices or networks via different wireless protocols such as Bluetooth, Zigbee, near-field communication (NFC), Wi-Fi, 5G, etc, and the devices include embedded sensors, actuators, processors, and transceivers. Architecture is not universally standardized in smart devices, but the most basic architecture typically includes a hardware layer (sensors), a network layer (network devices and servers), and an application layer (interface between the device and the network) through which clients can receive and transmit data for monitoring and control. Smart devices include a subset of devices that can be worn by the user to gain the operability and control that makes smart devices so convenient. These wearable smart devices, more commonly known as wearables, have become a growing market in the consumer industry but growth is also accelerating in the business and workplace market as well. Wearable smart devices can include smart watches, smart fitness bands, smart head mounted displays, and smart jewelry including rings.

Smart rings are becoming increasingly popular as a consumer electronic device. Smart rings are wearable devices loaded with mobile components such as sensors and NFC chips that are used for a variety of applications such as daily activity tracking, sleep monitoring, remote control, and a peripheral to support mobile smart devices. Smart rings are smaller and less cumbersome to wear than bands and watches. Smart rings have wireless capabilities allowing them to communicate with other devices such as smart phones, access points, wireless payment terminals, smart doors/locks, and wireless charging stations. Wireless capabilities require antennas to be designed and implemented in the smart ring, where NFC is the typical technology used for near range communications for payment, door access, etc. In addition, wireless charging can be achieved by using NFC protocols.

NFC is limited to short range communication (typically within 20 cm), and also consumes very little power while operating at very low frequency of approximately 13.56 MHz. Contactless digital payments that exist today utilize NFC technology to exchange data between readers and payment devices, NFC payments are widely used because they are contactless, encrypted, secure, and require less time to transact when compared to traditional methods of scanning a chip on a credit card or sliding a credit card through a reader. In addition to contactless payment and other data exchange options that exist, wireless charging can be achieved by utilizing NFC technology. Traditionally wireless charging has been implemented via Qi (RIP PMA) using a power source from the wall and energizing Qi coils emitting inductive charging between the charger and the device. Wireless charging using NFC technology includes slower charging speeds when compared to Qi charging, however, enables smaller devices to wirelessly charge as charging with Qi coils requires physically large coils.

One challenge when implementing NFC technology in a wearable such as a ring is that typically the NFC technology used in wireless charging and wireless payment (and/or other communication) uses different radios. The wireless charging radio has different characteristics than the wireless payment radio including for example different input impedances. The NFC antenna design seeks to match impedances for optimal performance therefore traditionally two separate antennas are required, one for wireless payment and one for wireless charging. Another challenge when implementing NFC antennas in a smart ring is that wireless payment applications require a large distance range (typically 10-20 cm) between the two electronic devices while needing less power transfer. Also, a wireless payment antenna may require support for various orientations of the ring relative to the payment terminal to allow users ease of use when in range of the payment terminal. As comparison, wireless charging requires larger power transfer and requires less distance range between the smart device and charging platform (typically 1-2 cm). Considering the differences in antenna design that are required, one NFC antenna is required for wireless payment activities and a separate NFC antenna is required for wireless charging activities. Designing and implementing two separate antennas inside a smart ring is extremely challenging due to limited available physical volume.

### BRIEF SUMMARY OF THE DISCLOSURE

The present disclosure relates to a compact, single near-field communication (NFC) antenna utilized for multiple functions, such as wireless charging and wireless payment radios, in a smart ring. In an embodiment, an antenna system includes an antenna; a plurality of chips; and an antenna matching network connected on one side to the plurality of chips and on another side to the antenna; wherein only one of the plurality of chips is active at a time with inactive chips have an impedance set combined with the antenna matching network to provide antenna matching with the active chip. To avoid multiple antennas and multiple matching networks, inactive chips are set to open having a corresponding impedance required for the matching network and the active chip. This approach provides a compact solution which is required in small form-factor devices such as smart rings.

In an embodiment, a near-field communication (NFC) antenna system includes an antenna; a plurality of chips; and an antenna matching network connected on one side to the plurality of chips and on another side to the antenna; wherein only one of the plurality of chips is active at a time with inactive chips have an impedance set combined with the antenna matching network to provide antenna matching with the active chip. The inactive chips are set to open having a corresponding impedance. The impedance can be set based on any of transmission line length, width, and gap between. The NFC antenna system can be utilized in a ring. The antenna can be a loop using a flexible printed circuit (FPC) and battery with a connection therebetween via a conductive material.

The plurality of chips can include a charging chip and a payment chip. First transmission lines from the antenna to the payment chip and second transmission lines from the antenna to the charging chip can be designed to match the antenna to both the payment chip and charging chip, the payment chip and the charging chip each having different input impedances. The charging chip can include rectifiers having an impedance of Zin_rectifiers when active and a capacitance of Ccharge_parasitic when inactive; the payment chip can include an impedance of Zin_booster when active and a capacitance of Cpay_parasitic when inactive; and a combined impedance of Zin_rectifiers and Cpay_parasitic can be substantially the same as a combined impedance of Ccharge_parasitic and Zin_booster. Zin_rectifiers and Zin_booster can be given; and Cpay_parastic and Ccharge_parastic can be selected by adjusting trace width, mutual gap and distance to ground plane.

In another embodiment, a method of operating a near-field communication (NFC) antenna system includes operating an antenna connected to an antenna matching network connected on one side to a plurality of chips and on another side to the antenna; and, at a given time, operating an active chip of the plurality of chips with inactive chips having an impedance set combined with the antenna matching network to provide antenna matching with the active chip.

In a further embodiment, a compact smart device includes a plurality of chips configured to implement functions associated with the compact smart device; an antenna connected to at least two chips of the plurality of chips; and an antenna matching network connected on one side to the at least two chips and on another side to the antenna; wherein only one of the at least two chips is active at a time with inactive chips have an impedance set combined with the antenna matching network to provide antenna matching with the active chip.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a depiction of the different applications of the NFC antenna in a smart ring device.

FIG. 2 is a block diagram of the existing industry NFC antenna configuration for wireless charging.

FIG. 3 is a block diagram of the existing industry NFC antenna configuration for wireless payment.

FIG. 4 is a block diagram for a single antenna design used for both wireless payment and wireless charging with separate impedance matching networks.

FIG. 5 is a block diagram for a single antenna design used for both wireless payment and wireless charging with a shared impedance matching network.

FIG. 6 is a block diagram for a single antenna design with a shared impedance matching network including the wireless charger/wireless payment terminal.

FIG. 7 depicts the equivalent and simplified circuit diagram for the single antenna design with a shared impedance matching network.

FIG. 8 is an equivalent and simplified circuit diagram for the single antenna design with relevant input impedances shown.

FIG. 9 is an equivalent and simplified circuit diagram for the single antenna design with switching open of NFC wireless payment radio.

FIG. 10 is an equivalent and simplified circuit diagram for the single antenna design with switching open of NFC wireless charging radio.

FIG. 11 depicts the equivalent and simplified circuit represented with the parasitic capacitance that exists when the payment chip is in the open state (turned off).

FIG. 12 depicts the equivalent and simplified circuit represented with the parasitic capacitance that exists when the charging chip in the open state (turned off).

FIG. 13 illustrates key circuitry and arrangement of antenna elements inside the smart ring.

FIG. 14 illustrates the NFC single antenna components implemented inside the smart ring.

FIG. 15 depicts the implementation of the NFC transmission lines to satisfy impedance matching.

### DETAILED DESCRIPTION OF THE DISCLOSURE

Again, in various embodiments, the present disclosure relates to a compact, single near-field communication (NFC) antenna utilized for multiple functions, such as wireless charging and wireless payment radios, in a smart ring. In an embodiment, an antenna system includes an antenna; a plurality of chips; and an antenna matching network connected on one side to the plurality of chips and on another side to the antenna; wherein only one of the plurality of chips is active at a time with inactive chips have an impedance set combined with the antenna matching network to provide antenna matching with the active chip. To avoid multiple antennas and multiple matching networks, inactive chips are set to open having a corresponding impedance required for the matching network and the active chip. This approach provides a compact solution which is required in small form-factor devices such as smart rings.

### Near Field Communications (NFC)

Near field communication (NFC) is a set of standards for establishing communication between two devices in close contact based on the principal of inductive coupling between two antennas present on NFC enabled devices. NFC is limited to short range communication (typically within 20 cm), consumes very little power, and operates at very low frequency of approximately 13.56 MHz. Some industry applied NFC applications include contactless payment, authentication and access control, and data delivery when smart devices are in close proximity (peer-to-peer data exchange). Secure communication is available by applying encryption algorithms similar to what is utilized with credit card transactions. NFC standards are industry defined and are based on existing radio-frequency identification (RFID) standards such as but not limited to ISO/IEC 14443, ISO/IEC 15963, and ISO/IEC 18092.

In addition to data transfer, NFC antennas embedded in a smart device can extract power from the transmitting antenna via mutual coupling that occurs by the magnetic field that is created between the two antenna inductances. The induced magnetic field is similar to the operation of a voltage transformer and can be used for contactless charging of the smart device. NFC antenna design is particularly challenging in a small form device as the antenna length is proportional to the wavelength (antenna length is inversely proportional to frequency). Considering NFC antennas operate at low frequency, the NFC antenna needs to be very large. NFC antennas usually consist of a large, wrapped coil of conductor (inductance) which requires a large amount of volume to implement. NFC antennas are designed with variables that affect antenna performance such as antenna transmission line length, transmission line width, transmission line gap, placement of antenna to the ground plane, and magnetic shielding.

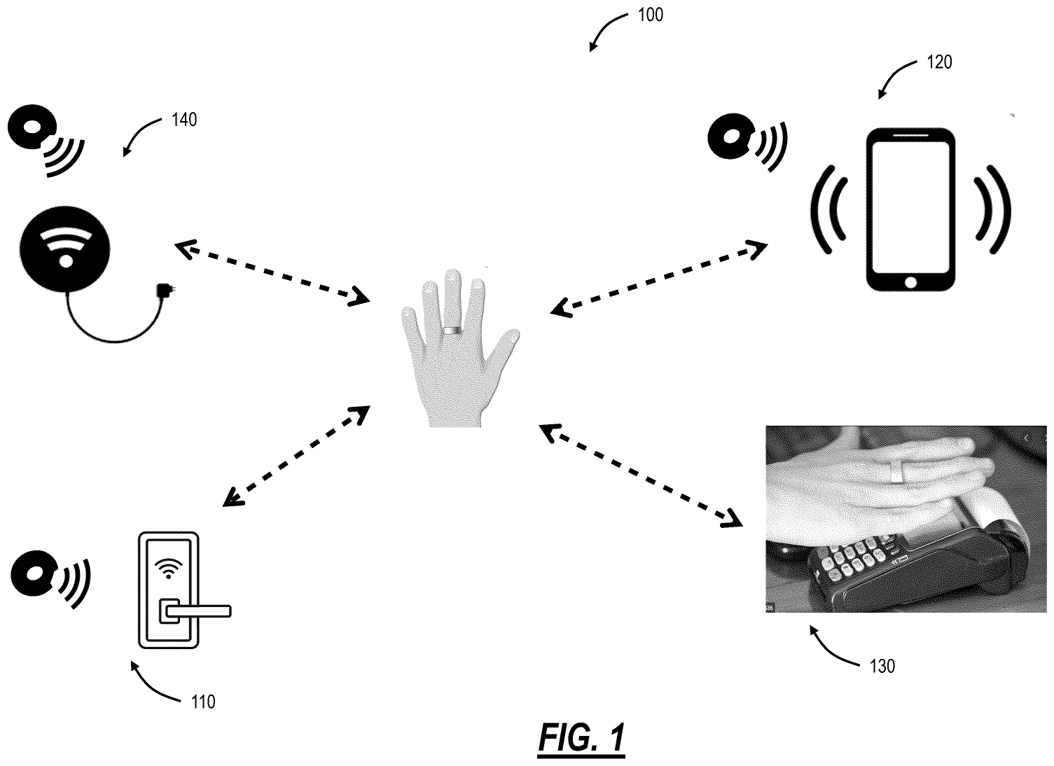

FIG. 1 depicts some examples of NFC applications 100. With a smart ring equipped with NFC antennas some applications that currently exist include smart door access 110. The smart ring can also act as a smart phone periphery 120 which can be used to unlock your phone, set alarms, receive messages or call notifications, control applications such as music, etc. One of the most well-known applications of NFC technology is contactless payment 130 which can be achieved with a smart ring equipped with an NFC antenna. Wireless charging 140 can also be achieved by utilizing a power source from a dedicated power supply such as a wall outlet to energize the charging base antenna and creating a magnetic field that can be received by the smart ring antenna. Wirelessly charging via NFC 140 is slower and less power driven than traditional induction charging but the charging platform can be a much smaller form factor. Those skilled in the art will recognize the NFC technology that can be utilized with a smart ring 100 is presented for illustration purposes but can include any number of applications and capabilities that can utilize the near range communication frequency.

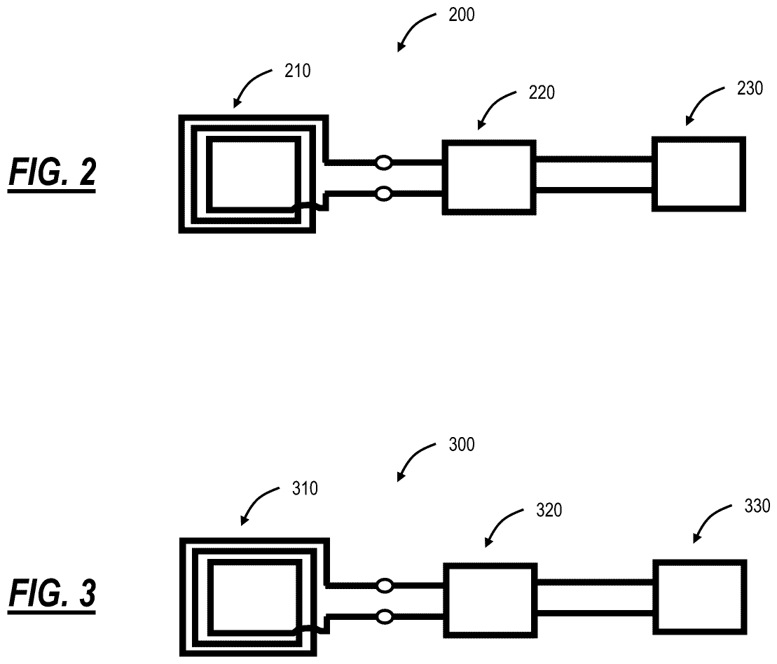

FIG. 2 is a block diagram of the existing industry NFC configuration for wireless charging and as a comparison FIG. 3 is a block diagram of the existing industry NFC configuration for wireless payment. Although the illustrations shown appear to be identical, not depicted in the illustration the wireless antenna circuits (200 for wireless charging, 300 for wireless payment) are very different from one another as they are designed and implemented for different configurations and operations. Wireless payment for instance requires a large range (typically 10-20 cm) while requiring less power transfer where wireless charging requires more power transfer while needing less range (typically 1-2 cm). The wireless antenna shown in 210 for wireless charging requires specific input impedances, power transmission sensitivities, etc. In addition, since the antenna in 200 is used for charging the power is transferred from the transmitter to the antenna 210 and then as shown in 200 thru the antenna matching network 220, to the NFC wireless charging radio 230, the radio 230 transmits/converts the source power to Direct Current (DC) to charge the smart device. In contrast the wireless payment circuit shown in 300 is used for communication and the payment terminal would send energy to the wireless payment radio chip 330 (also referred herein as chip), via the antenna 310, the energy would be modulated, and the transmitter (payment terminal) could get feedback from the circuit 300 on energy emitted. Another difference in antenna design and implementation is the fact that wireless payment may require support for various orientations of the ring relative to the payment terminal, this would allow the user the flexibility to not be required to orient the ring a certain way while in close contact to the payment terminal.

The antenna is the largest volume component in the radio/antenna design, this is due to the fact that the NFC wavelength is very high (frequency is very low at approximately 13.56 MHz). Since the length of an antenna is proportional to wavelength, the antenna needs to be very large and is often coiled to create the inductance needed, which requires a large volume and is a challenge in small form smart device application. The antenna circuits shown on 200 (wireless charging) and 300 (wireless payment) also need to be designed and implemented to meet requirements such as impedance matching for optimal performance. The antenna matching network for the wireless charging radio is shown on 220 and the antenna matching network for the wireless payment is shown on 320, with the antenna circuits consisting of different elements with different impedances the matching network (220, 320) would be designed specifically for each antenna circuit to create a matched impedance between a source and a load. The antenna matching network is designed and implemented to strive to have a perfect matching impedance, as if the impedance of the line feeding the antenna and the antenna impedance do not match the source can experience complex impedance causing signal reflection and inefficient power transfer. The problem with having two different radios and antennas in a smart ring is that implementing these two features is extremely challenging due to the limited available physical volume in the small form smart ring.

### Impedance Matching

Impedance matching is a key design and implementation consideration of any antenna circuit as matching source impedance to load impedance allows maximum power to transfer from source to final load and also minimizes the signal reflection and interference in the signal. With a simplified antenna circuit that consists of transmitter impedance, transmission line impedance, and antenna impedance, when the antenna (load) impedance is fixed and the transmitter (source) impedance is set equal to the load impedance, then the transmission line can be designed such that its impedance is also equal to the antenna (load) impedance. This impedance matching concept gets much more complex as the antenna circuit components get more complex and consist of elements such as capacitance, inductance, and resistance in series and parallel. Transmission lines are a crucial part of the power transfer between the antenna and radio chip and often takes the form of a circuit trace. The transmission line has its own characteristic impedance determined by many factors including length, width, and line gap between transmission lines. Impedance matching circuits (220, 320) are designed into each specific antenna circuit and can include transformers, adjustable networks of lumped resistance, capacitance, inductance, and/or properly designed transmission lines.

### Single NFC Antenna for Wireless Payment and Charging

The solution to the problems that exist with having two separate NFC antennas in a small form smart ring application is to create a single antenna design that works for both wireless charging and wireless payment radios. The antenna portion of the antenna circuit requires the largest volume compared to any of the other elements of the antenna circuit as depicted in 200 and 300. The antenna (210, 310) typically requires more volume than the combined volume of the antenna matching network (220, 320) and the radio (230, 330). Removing one of the antennas (210, 310) would result in the greatest volume savings in the smart ring.

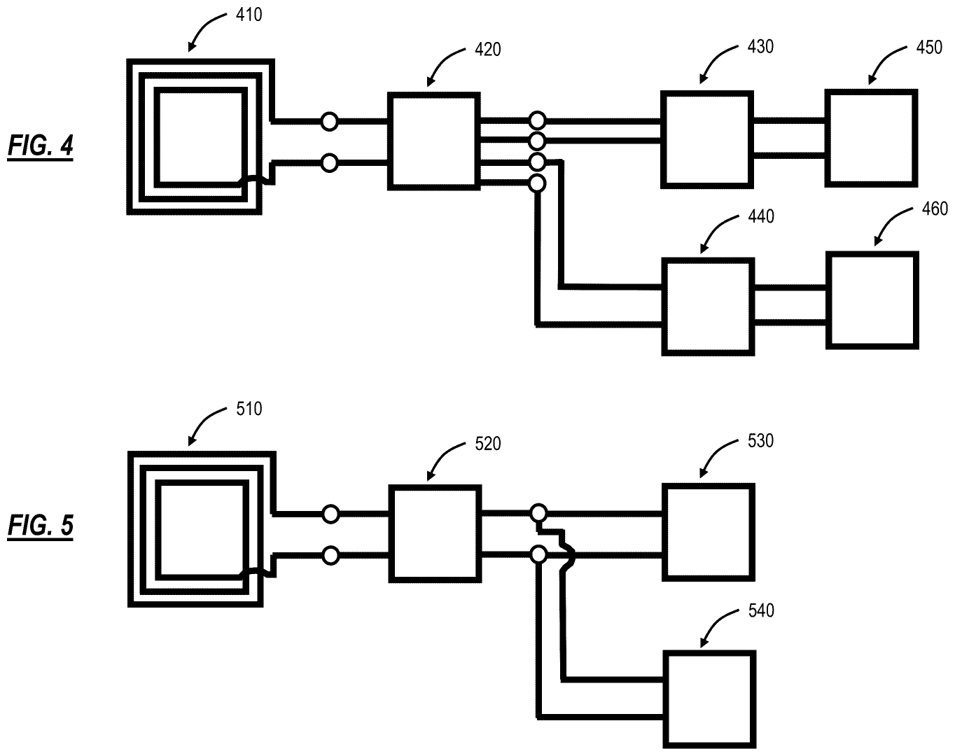

As described in the disclosed two possible configurations for achieving a single antenna design are presented in block diagrams depicted in FIG. 4 and FIG. 5. The single antenna design in FIG. 4 includes a single antenna 410, two separate antenna matching networks, one for wireless charging 430 and one for wireless payment 440. The single antenna design circuit also includes two separate NFC radios, one for wireless charging 450 and one for wireless payment 460. To have a single antenna for both radio circuits, the solution presented in FIG. 4 includes a double pole double throw (DPDT) switch 420 which functions to switch between the wireless charging radio circuit (430, 450) and the wireless payment radio circuit (440, 460). By utilizing the microcontroller unit (MCU) embedded inside the ring to operate the DPDT switch 420, the switch can be used to turn off the wireless charging radio 450 when the wireless payment radio 460 is being used and vise versa. In comparison to FIG. 4, the single antenna design depicted in block diagram (FIG. 5) includes a single antenna 510 with a single antenna matching network (520) which is utilized for two separate radios (530, 540). FIG. 5 merges the wireless charging radio (530) and wireless payment radio (540) together in parallel with a single antenna matching network 520. The block diagram shown depicts an overall circuit diagram, the details of this implementation and design are further covered in the disclosed.

The benefits of the FIG. 4 single antenna design are that it requires less volume in the ring than classical existing industry two antenna configurations shown in FIG. 2 and FIG. 3. However, the addition of the DPDT switch 420 in the antenna circuit adds an element making the circuit have 6 total elements. It should be noted that the DPDT switch element 420 is much smaller than the antennas (210, 310) so even though FIG. 4 has the same number of elements as the two-antenna existing industry configuration shown in FIG. 2 and FIG. 3, implementation of the circuit shown in FIG. 4 would result in much less volume occupied in the smart ring.

The benefits of FIG. 5 over the classical existing industry two antenna configuration includes all the benefits of FIG. 4 in addition, the circuit shown in FIG. 5 requires even less volume for implementation in the ring as it only requires four circuit elements. Combining the two impedance matching circuits (220, 320) into a single impedance matching circuit that is shared between the wireless charging radio 530 and the wireless payment radio 540 reduces the number of elements to four total and provides even more volume reduction inside the ring. The challenge with the configuration in FIG. 5 is that as mentioned previously the antenna circuit must be designed with a certain impedance which is unique to the specific radio, so by sharing the antenna matching network 520 between the radios the input impedance would need to change for each radio. The other potential challenge is the radiation interference that can exist with these antenna circuits in this configuration when the two radios have different impedances. The circuit shown in FIG. 5 is the optimal single NFC antenna configuration, therefore the disclosed will further describe the design and implementation of this configuration.

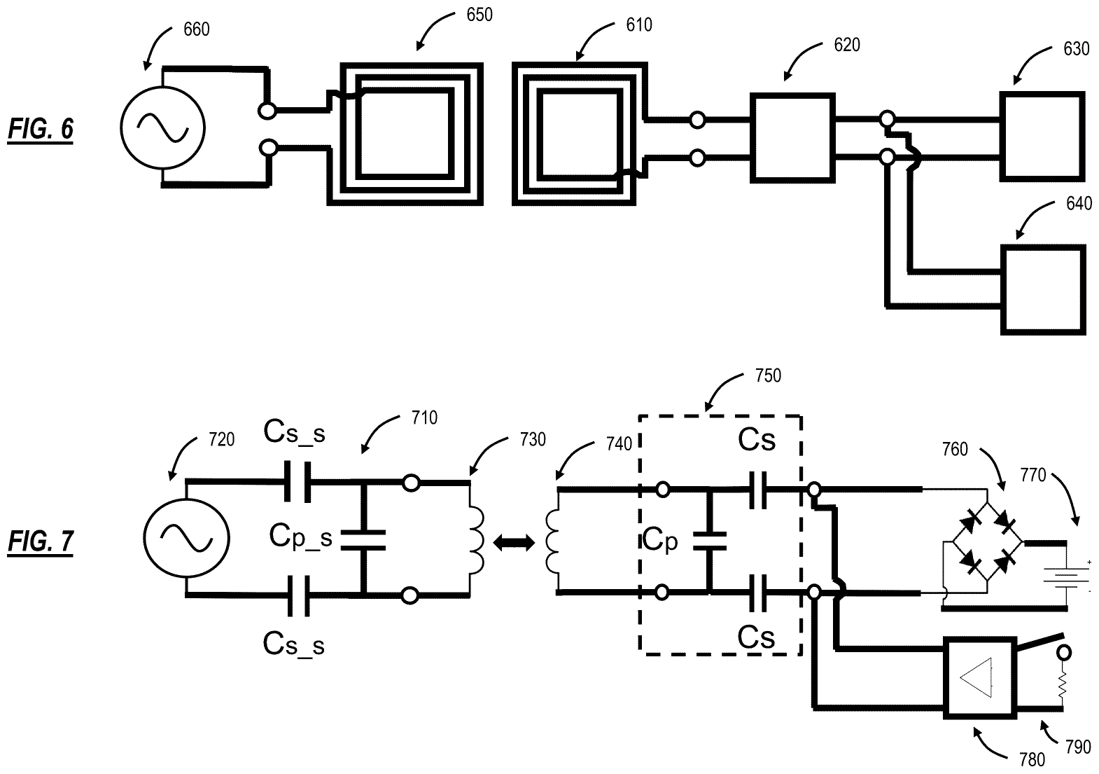

Further building upon the block diagram in FIG. 5, the antenna circuit block diagram is shown with the payment terminal/charging station NFC transmitting antenna 650 included as shown in FIG. 6. The payment terminal/charging station includes the alternating current (AC) energy source 660. It should be noted that the energy source from the payment terminal/charging station is AC power, but the use of the AC power supply is different in the antenna circuit for wireless charging compared to wireless payment. With respect to wireless charging the AC source is transformed into DC power 630, for wireless payment the AC source is modulated by the payment radio 640. The equivalent and simplified circuit diagram is shown in FIG. 7 which includes the NFC payment terminal/charging station 710 shown which includes the AC power source 720, as well this circuit is also the data source for antenna circuit. The payment terminal/charging station NFC antenna 730 and the ring NFC antenna 740 interact via magnetic field coupling. The antenna matching network is depicted with an impedance matching circuit 750, NFC wireless charging radio shown with AC to DC rectifiers 760, DC power storage 770, and NFC wireless payment radio shown with equivalent modulation booster 780 and data modulation load 790. Energy in this equivalent and simplified circuit diagram flows from left to right from AC power source 720 to DC power storage 770 (wireless charging) and data modulation load 790 (wireless payment).

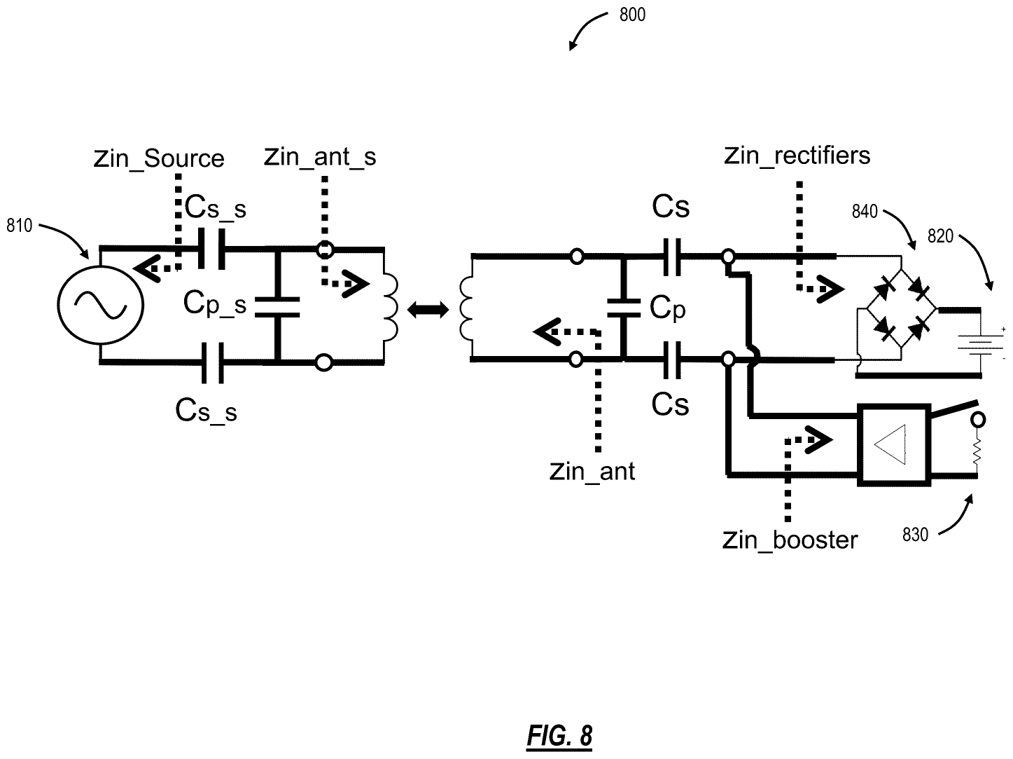

FIG. 8 depicts the equivalent and simplified circuit diagram shown in FIG. 7 for the single antenna design with relevant input impedances shown. It should be noted that impedance matching is necessary for radio/antenna circuits to ensure maximum power transfers between the source and the load. Impedance matching minimizes the signal reflections therefore it is crucial that each device in the antenna circuit is matched to its load. There are five (5) input impedances that must be matched from the AC power source 810 to be delivered to the DC storage 820 and from the AC power source 810 to be modulated by the modulation load 830. The input impedances are shown by dotted line/arrows in 800 (Zin_Source, Zin_ant_s, Zin_ant, Zin_rectifiers, and Zin_booster). The problem is that Zin_ant must match and work for all relevant impedances even though all the relevant impedances are not the same value:
a. Typically, Zin_Source ranges from a few ohms to 50 ohm however most often Zin_Source is approximately 20 ohm for maximal power output which is desired to achieve the desired range of operation and power transfer.
b. Typically, Zin_ant_s and Zin_ant is a highly inductive impedance with less than 1 ohm in resistance and a few nH (nano-Henry) in inductance.
c. Typically, Zin_booster is approximately 50 ohm.
d. Typically, Zin_rectifiers depend on how much current flows through the rectifiers 840. For a typical current flow in a small wearable device of 120-130 mA the input impedance (Zin_rectifiers) can be as large as 150 ohm.
   If Zin_ant_s is matched to 20 ohm, it will not optimally couple to Zin_ant as Zin_ant is matched to 150 ohm. If Zin_ant is matched to Zin_rectifiers (150 ohm), Zin_ant will not be matched to Zin_booster (approx. 50 ohm). Impedance matching becomes a problem in this configuration as the rectifier impedance Zin_rectifiers is very large at 150 ohm, the booster impedance Zin_booster is 50 ohm, and the input antenna Zin_ant is highly inductive (large impedance).

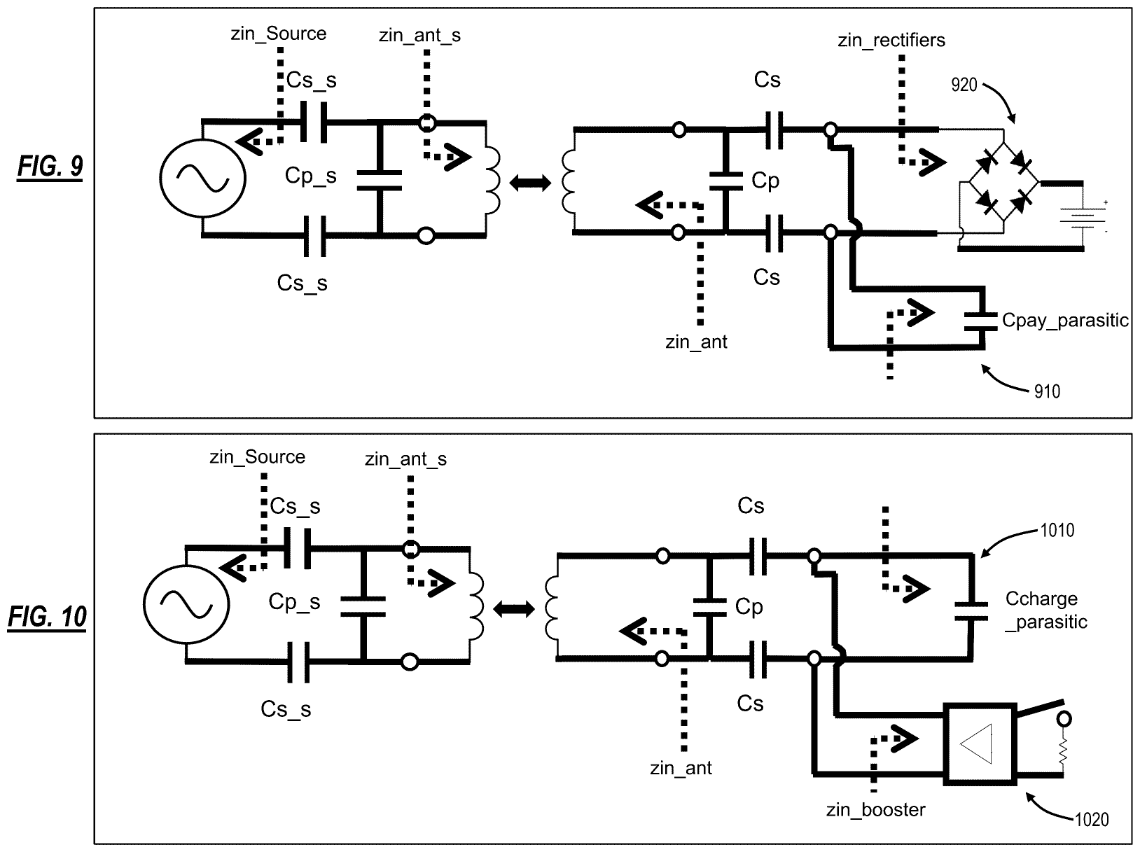

As shown in FIG. 9 to resolve the issue of impedance mismatch when using the charging radio, switching the payment chip in the payment radio to the open state by utilizing the microcontroller unit (MCU) inside the ring would cause a change to the input impedance 910. The result of the open state in the payment chip would be a large parasitic capacitance dominated by the gap between transmission differential lines and gap between transmission lines and ground. A parasitic capacitance is a capacitance that exists between the parts of an electronic component because of the proximity to one another, in this case it would be a capacitance in parallel with the rectifiers 920 and the impedance Zin_rectifiers. The same switching can be applied to the wireless charging radio when the payment radio is being operated. As shown in FIG. 10, switching the charging radio chip to the open state by utilizing the MCU inside the ring turns it into a parallel parasitic capacitance 1010 in parallel with the data modulation load 1020 and the impedance Zin_booster. By reducing the complex circuit shown in FIG. 8 to the simplified circuit shown in FIG. 9 and FIG. 10 impedance matching becomes a possibility.

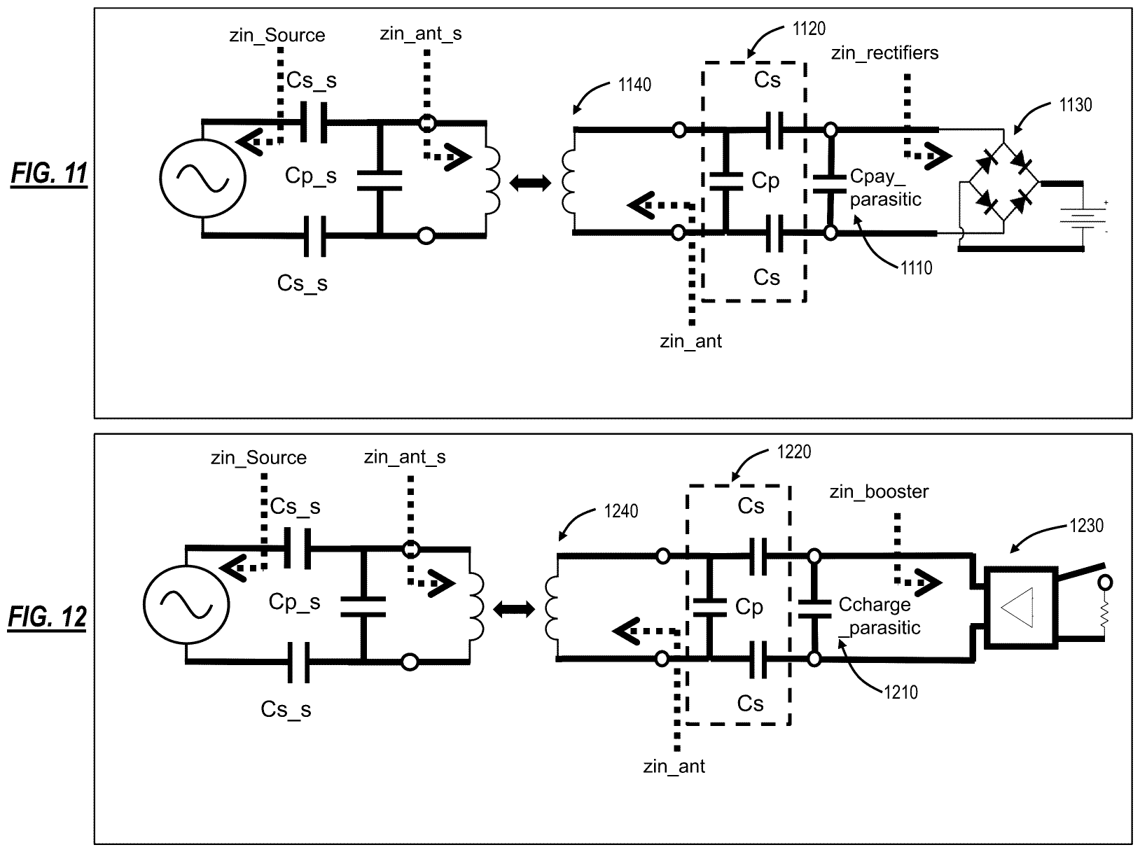

FIG. 11 further shows the equivalent and simplified circuit represented with the payment chip open (turned off) which serves as a parallel parasitic capacitance 1110. Similarly, FIG. 12 shows the equivalent and simplified circuit represented with the charging chip open (turned off) which serves as a parallel parasitic capacitance 1210. The MCU controls the radio chips and is able to turn them on/off as the MCU identifies when charging and payment is being utilized. The parasitic capacitance that is a result of turning the radio chips in the off state physically consists of a transmission line that is located between the antenna matching network (1120, 1220) and the rectifier (1130) or booster (1230). Design of the transmission lines from the payment antenna 1240 to the payment chip and design of the transmission lines from the charging antenna 1140 to the charging chip is key in making the antenna impedance match both payment and charging chip even though they have different input impedance. Combined impedance of Zin_rectifiers plus Cpay_parasitic 1110 as illustrated in FIG. 11 needs to be equal or similar to the combined impedance of Ccharge_parasitic 1210 plus Zin_booster as illustrated in FIG. 12. Zin_rectifiers and Zin_booster impedances are a known value, where Cpay_parastic and Ccharge_parastic are chosen so that they satisfy equation 1 below and can be easily implemented in the layout design by adjusting the circuit trace width, mutual gap and distance to ground plane on the transmission line. The equation below solves for the two parallel impedances in each circuit being equal or very similar.

$$\frac{Z i {n}^{r e c t i f i e r} \times {Cparasitic}^{p a y}}{Zi {n}^{r e c t i f i e r} + {Cparasitic}^{p a y}} \approx \frac{Z i {n}^{b o o s t e r} \times {Cparasitic}^{c h a r g e}}{Zi {n}^{b o o s t e r} + {Cparasitic}^{c h a r g e}} \qquad ( Equation 1 )$$

### Single NFC Antenna Element Implementation

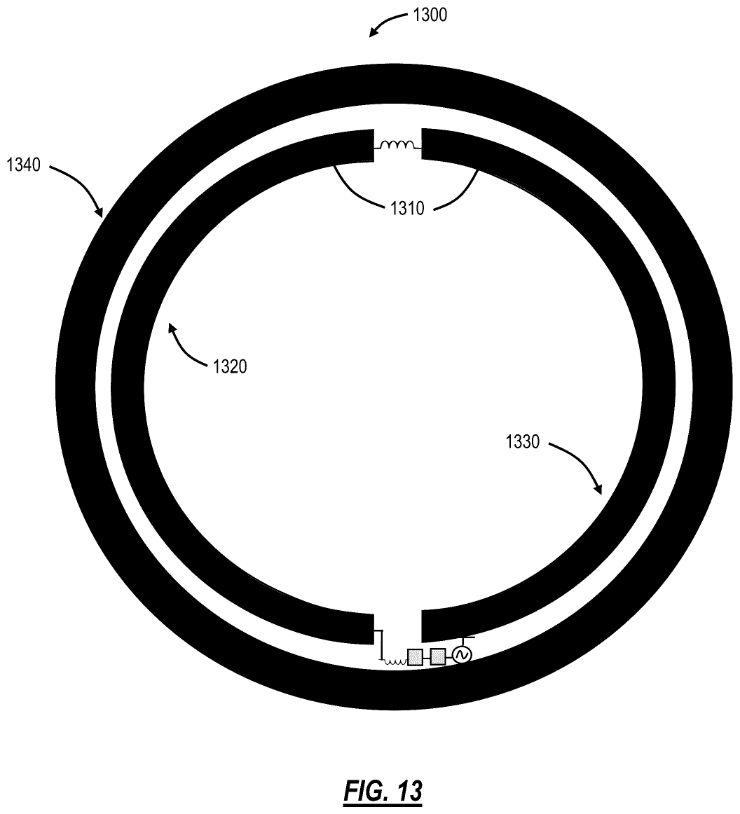

FIG. 13 illustrates key circuitry and arrangement of the antenna elements inside the smart ring 1300. The single NFC antenna is implemented by forming a loop 1310 inside the ring bezel 1340. This loop includes using flexible printed circuit (FPC) RF board 1330 that includes the NFC chip, power amplifiers, low noise amplifiers, MCU, etc. on one end and the battery 1320 (battery jacket or conductive sheet/strip on the battery) on the opposite side. The FPC and battery are connected with a conductive material such as clips or sheets, alternatively chokes/inductors may be used for connection. A choke/inductor is used to block higher frequency while passing direct current (DC) and lower frequencies in an electrical circuit. Those skilled in the art will recognize the illustration shown 1300 emits elements of the antenna circuitry, RF shielding, etc. to highlight elements of the smart ring design that assist in describing the single NFC antenna implementation. The smart ring can include any number of components and design elements not shown here and further described herein.

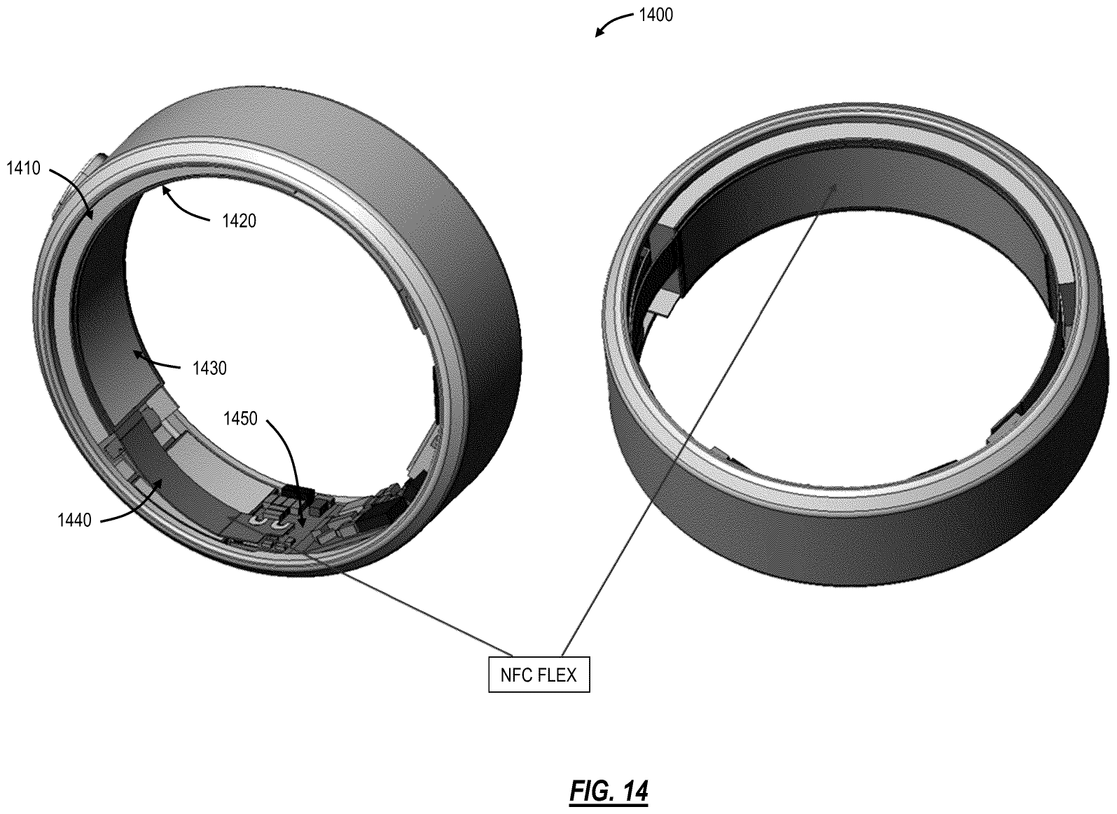

FIG. 14 further illustrates the NFC antenna in the form of flex and battery implementation inside the smart ring 1400. As can be compared to FIG. 13, the battery 1410 is embedded on one side of the loop and the FPC RF board 1450 on the other side. By placing the NFC antenna in the form of a flexible circuit 1430 on the battery 1410 with a ferrite sheet between the NFC flex and battery 1420 the antenna can be implemented into the small form ring application without interference. As depicted in 1440 the shaded portion depicts an NFC antenna flexible tail (part of NFC flex and soldered to the FPC), the FPC further extends throughout the inside of the ring 1450 and includes the other circuit components. The FPC 1450 is where all the chips and components exist that make up the antenna radios.

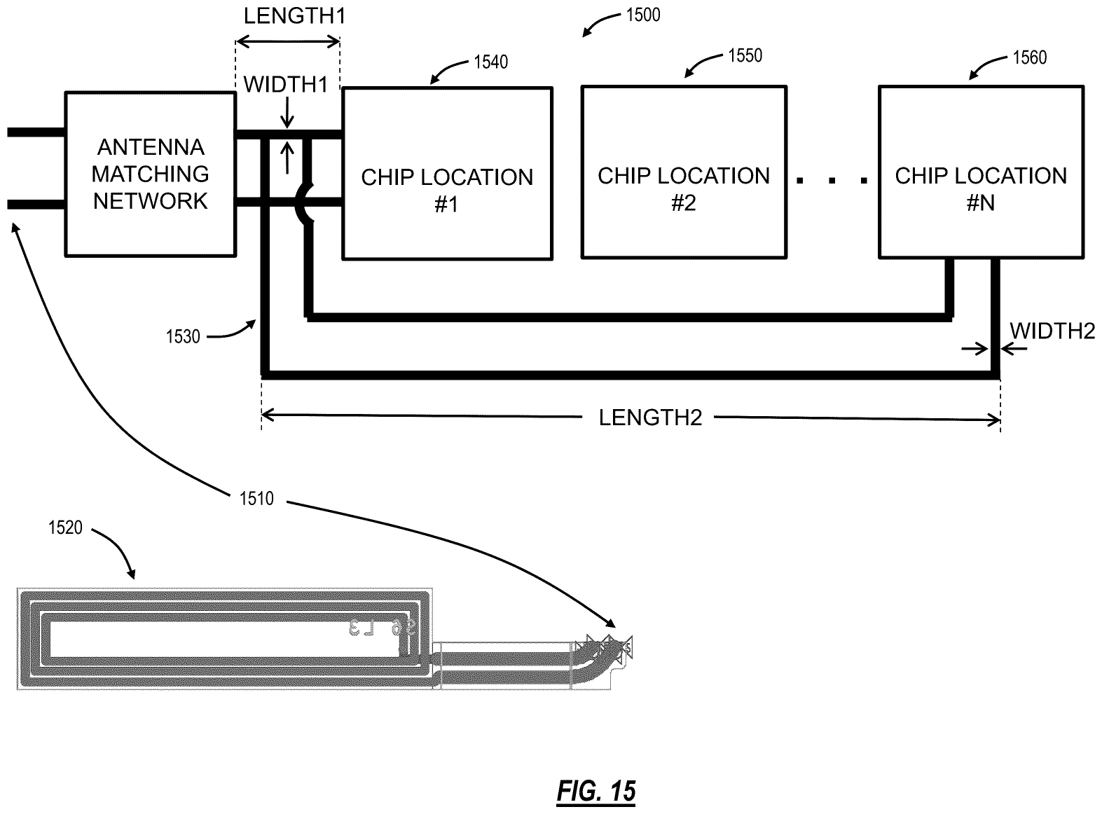

FIG. 15 depicts the implementation of the NFC transmission lines from the antenna matching network to the payment charging chip (1530) to satisfy impedance matching. A block diagram and a representative antenna trace is shown 1500. The block diagram depicts the transmission lines that exist between the antenna matching network and the location of any of the radio chips (payment or charging). The payment and charging chips can be located at any one of the chip locations shown in the block diagram (1540, 1550, 1560) or multiple chips can be located at the same location. To meet the impedance matching condition shown in Equation 1 the amount of capacitance is determined by the transmission line width, mutual gap, and gap to ground plane for the transmission line shown between the antenna matching network and the chips. As illustrated in the block diagram 1500 the payment chip and charging chip could be at any of the locations shown (1540, 1550, 1560). The payment chip and the charging chip could even be at the same location in which chip location #1 (1540) is on top of the FPC 1450 and chip location #2 (1550) is on the bottom of the FPC 1450. The NFC flex tail (1440) solder point to the FPC (1450) is shown on 1510 which shows the antenna illustration 1520 and also represents this connection on the block diagram as the antenna lines connected to the antenna matching network on the block diagram. The NFC antenna loop (1520) is shown as it would be implemented in the ring as the flexible coiled circuit 1430 located underneath the battery 1410. The flexibility to be able to locate these wireless radio chips throughout the ring allows the designer the ability to perform impedance matching by selecting a location for the chips that gives the best impedance. The transmission line design which is dependent on the chip location (1540, 1550, 1560) would select the parasitic capacitance when the wireless payment chip is in the off position (Cpay_parasitic) and when the wireless charging chip is in the off position (Charge_parasitic).

Referring to the block diagram 1500, the longer the transmission line length between the antenna matching network and the chip (Length1) and the wider the line width (Width1), the more capacitance that exists. Inversely, the shorter Length1 and the narrower Width1 the less capacitance that exists. The less gap that exists between the transmission lines along Length1 the more capacitance, inversely, the more gap that exists between the transmission lines along Length1 the less capacitance. The less gap between transmission lines along Length1 and the underlying ground plane the more capacitance, inversely, the more gap between transmission lines along Length1 and the underlying ground plane the less capacitance. The comparison between length, width, mutual gap, and gap to ground plane also applies Length2 and Width2 the same as it is described for Length1 and Width1 shown on 1500.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc. described herein can be used in any and all combinations with each other.

What is claimed is:

1. A near-field communication (NFC) antenna system comprising:
an antenna;
a plurality of chips; and
an antenna matching network connected on one side to the plurality of chips and on another side to the antenna;
wherein only one of the plurality of chips is active at a time with inactive chips have an impedance set combined with the antenna matching network to provide antenna matching with the active chip.

2. The NFC antenna system of claim 1, wherein the inactive chips are set to open having a corresponding impedance.

3. The NFC antenna system of claim 1, wherein the impedance is set based on any of transmission line length, width, and gap between.

4. The NFC antenna system of claim 1, wherein the plurality of chips includes a charging chip and a payment chip.

5. The NFC antenna system of claim 4, wherein first transmission lines from the antenna to the payment chip and second transmission lines from the antenna to the charging chip are designed to match the antenna to both the payment chip and charging chip, the payment chip and the charging chip each having different input impedances.

6. The NFC antenna system of claim 4, wherein:
the charging chip includes rectifiers having an impedance of Zin_rectifiers when active and a capacitance of Ccharge_parasitic when inactive;
the payment chip includes an impedance of Zin_booster when active and a capacitance of Cpay_parasitic when inactive; and
a combined impedance of Zin_rectifiers and Cpay_parasitic is substantially the same as a combined impedance of Ccharge_parasitic and Zin_booster.

7. The NFC antenna system of claim 6, wherein:
Zin_rectifiers and Zin_booster are given; and
Cpay_parastic and Ccharge_parastic are selected by adjusting trace width, mutual gap and distance to ground plane.

8. The NFC antenna system of claim 1, wherein the NFC antenna system is utilized in a ring.

9. The NFC antenna system of claim 1, wherein the antenna is a loop using a flexible printed circuit (FPC) and battery with a connection therebetween via a conductive material.

10. A method of operating a near-field communication (NFC) antenna system comprising:
operating an antenna connected to an antenna matching network connected on one side to a plurality of chips and on another side to the antenna; and
at a given time, operating an active chip of the plurality of chips with inactive chips having an impedance set combined with the antenna matching network to provide antenna matching with the active chip.

11. The method of claim 10, wherein the inactive chips are set to open having a corresponding impedance.

12. The method of claim 10, wherein the impedance is set based on any of transmission line length, width, and gap between.

13. The method of claim 10, wherein the plurality of chips includes a charging chip and a payment chip.

14. The method of claim 13, wherein first transmission lines from the antenna to the payment chip and second transmission lines from the antenna to the charging chip are designed to match the antenna to both the payment chip and charging chip, the payment chip and the charging chip each having different input impedances.

15. The method of claim 13, wherein:
the charging chip includes rectifiers have an impedance of Zin_rectifiers when active and a capacitance of Ccharge_parasitic when inactive;
the payment chip includes an impedance of Zin_booster when active and a capacitance of Cpay_parasitic when inactive; and
a combined impedance of Zin_rectifiers and Cpay_parasitic is substantially the same as a combined impedance of Ccharge_parasitic and Zin_booster.

16. The method of claim 15, wherein:
Zin_rectifiers and Zin_booster are given; and
Cpay_parastic and Ccharge_parastic are selected by adjusting trace width, mutual gap and distance to ground plane.

17. The method of claim 10, wherein the antenna is a loop using a flexible printed circuit (FPC) and battery with a connection therebetween via a conductive material.

18. A compact smart device comprising:
a plurality of chips configured to implement functions associated with the compact smart device;
an antenna connected to at least two chips of the plurality of chips; and
an antenna matching network connected on one side to the at least two chips and on another side to the antenna;
wherein only one of the at least two chips is active at a time with inactive chips have an impedance set combined with the antenna matching network to provide antenna matching with the active chip.

19. The compact smart device of claim 18, wherein the at least two chips include a charging chip and a payment chip.

20. The compact smart device of claim 18, wherein the compact smart device is a ring.
